(19) United States
(12) Patent Application Publication
(10) Pub. No.: US 2025/0058841 A1
(43) Pub. Date: Feb. 20, 2025

(54) TRANSMISSION MECHANISM OF MICRO CRAWLING ROBOT AND MICRO CRAWLING ROBOT

(71) Applicant: ZHEJIANG UNIVERSITY, Hangzhou (CN)

(72) Inventors: Yide LIU, Hangzhou (CN); Shaoxing QU, Hangzhou (CN); Yanhong CHEN, Hangzhou (CN); Bo FENG, Hangzhou (CN); Dongqi WANG, Hangzhou (CN)

(21) Appl. No.: 18/939,490

(22) Filed: Nov. 6, 2024

Related U.S. Application Data
(63) Continuation of application No. PCT/CN2022/132609, filed on Nov. 17, 2022.

(30) Foreign Application Priority Data
May 12, 2022 (CN) 202210513896.8

(51) Int. Cl. B62D 57/02

(52) U.S. Cl. CPC B62D 57/02

(57) ABSTRACT

A transmission mechanism of a micro crawling robot and the micro crawling robot. The transmission mechanism is a parallel mechanism with three branch chains and two degrees of freedom, and comprises: a fixed platform; a moving platform; a constraint limb comprising a first rotating joint S₁₁ and a second rotating joint S₁₂, which generate the functions of restraining the lifting motion and the twisting motion of the moving platform, respectively; a first actuation limb comprising third to seventh rotating joints S₂₁-S₂₅, wherein the third rotating joint S₂₁ is a actuation joint and the rest are transmission rotating joints; and a second actuation limb comprising eighth to twelfth rotating joints S_{31-S35}, wherein the eighth rotating joint S₃₁ is a actuation joint, and the rest are the transmission rotating joints.

### CROSS-REFERENCE TO RELATED APPLICATIONS

The present application is a continuation of International Application No. PCT/CN2022/132609, filed on Nov. 17, 2022, which claims priority to Chinese Application No. 202210513896.8, filed on May 12, 2022, the contents of both of which are incorporated herein by reference in their entireties.

### TECHNICAL FIELD

The present disclosure relates to a transmission mechanism of a crawling robot and the crawling robot, and mainly relates to a transmission mechanism of a miniature intelligent crawling robot with high mobility.

### BACKGROUND

A micro crawling robot refers to the crawling robot in a millimeter scale, that is, the characteristic length of the robot body is in the order of several millimeters to dozens of millimeters. At present, the crawling mode of micro crawling robot is still similar to that of inchworm, but due to the small size (with the size of coins) and the light weight (generally within 10 g), the motion mode and design and manufacturing strategy adopted by the robot are different from those of large-scale robots. Large-scale robots, such as wheeled robots or legged robots, often use motors or hydraulic drives, but for micro crawling robots, electric motors and motors are no longer suitable due to their large sizes. Designers will design the corresponding transmission mechanism according to the driving characteristics of different drivers, and then adopt the corresponding driving system and control system.

A body of some microrobots does not include devices such as controllers and batteries, so they need to be connected to external devices via cables to provide energy and control signals, a movement state known as a tethered movement. At present, the research has proved that the microrobot in the tethered state can realize high-speed locomotion (Amin, R., & Dario, P. (2014). High-speed locomotion for a quadrupedal microrobot. International Journal of Robotics Research, 33(10), 1355-1370). However, in practical use, the microrobot in the tethered state always needs to be dragged by cables and cannot realize the function of large-scale movement. For tasks such as cave exploration and extraterrestrial exploration, it is necessary to design an untethered micro robot (Dai, H., & Rus, D. (2019). Toward autonomy in sub-gram terrestrial robots. Annual Review of Control, Robotics, and Autonomous Systems, 2, 255-280) that can carry a power and a controller.

Maneuverability refers to the movement ability of microrobots, which generally includes robot speed, agility in turning and so on. The faster the speed of the robot and the smaller the turning radius, it is believed that the higher the mobility of the robot (Principles of Animal Locomotion). For microrobots, speed is the most important measure (Dai, H., & Rus, D. (2019). Toward autonomy in sub-gram terrestrial robots. Annual Review of Control, Robotics, and Autonomous Systems, 2, 255-280).

In the design and manufacture of micro crawling robots, the traditional machining, cutting, stamping and casting methods are no longer applicable due to the small size of the parts involved, and it is necessary to adopt specific machining methods to manufacture micro-drivers and transmission mechanisms.

However, designing an efficient and flexible transmission mechanism for the specific locomotion mode of micro crawling robot is challenging. Because the mechanism with the highest transmission efficiency is often a parallel mechanism, the design of parallel mechanism with few degrees of freedom is an open problem in the field of mechanism. For the design of this kind of mechanism, it is necessary to use complex theoretical tools (Huang, Z., & Li, Q. C. (2002). General methodology for type synthesis of symmetrical lower-mobility parallel manipulators and several novel manipulators. The International Journal of Robotics Research, 21(2), 131-145).

The design of a micro crawling robot with high automation and high mobility is an internationally recognized problem. This is because the choice of drivers is limited when designing robots on millimeter scale, which brings difficulties to the design and manufacture of corresponding transmission mechanisms. At present, there is no micro crawling robot that can achieve the movement speed that is more than 5 times the body length per second without tethering. At present, the microrobot with the best sports performance is the HAMR-F introduced by Harvard University, and its moving speed is 3.8 times of body length per second (Dai, H., & Rus, D. (2019). Toward autonomy in sub-gram terrestrial robots. Annual Review of Control, Robotics, and Autonomous Systems, 2, 255-280).

The difficulty in designing efficient transmission mechanisms for small-scale crawling robots results in slow speeds, weak turning abilities, and poor maneuverability, severely hindering the application of crawling robots in a wider range of fields.

### SUMMARY

In view of the shortcomings of the prior art, the present disclosure provides a transmission mechanism for a small-scale crawling robot, which can realize a high-mobility crawling function.

The principle of screw theory (Huang Z, Li QC. General Methodology for Type Synthesis of Symmetrical Lower-Mobility Parallel Manipulators and Several Novel Manipulators. The International Journal of Robotics Research. 2002; 21(2):131-145) is taken and quoted as a reference, but the present disclosure is not limited thereto. The inventor first proposed a two-degree-of-freedom micro-parallel mechanism as a transmission mechanism for micro crawling robots to meet the requirements of high automation and high mobility.

According to the preferred embodiment of the present disclosure, the transmission mechanism is a centimeter-scale mechanical structure, which is a parallel mechanism with three branch chains composed of connecting rods. In an embodiment, a transmission mechanism for a micro crawling robot includes a fixed platform, a moving platform, a constraint limb, a first actuation limb and a second actuation limb. The constraint limb includes a first rotating joint and a second rotating joint, which generate the functions of restraining a lifting motion and a twisting motion of the moving platform, respectively; the first actuation limb and the second actuation limb each have an actuation joint, and when the driving joints of the two actuation limbs move synchronously, the transmission mechanism generates a lifting motion, which causes the micro crawling robot to move forward; when the movements of the driving joints of the two actuation limbs are out of synchronization, the transmission mechanism generates a twisting motion, which causes the micro crawling robot to turn. The axes of the lifting motion and the twisting motion are orthogonal. According to the present disclosure, shunt connection and parallel connection can be used interchangeably.

According to the preferred embodiment of the present disclosure, the lifting motion and twisting motion of the transmission mechanism can be superimposed, that is, the synchronous component of the actions of the two actuation limbs will lead to the lifting of the transmission mechanism, and the asynchronous component of the two actuation limbs will lead to the twisting of the transmission mechanism, so that the robot can move forward and turn at the same time.

According to the preferred scheme of the present disclosure, the first actuation limb and the second actuation limb include five rotating joints, respectively.

The first actuation limb includes a third rotating joint to a seventh rotating joint.

The third rotating joint is arranged on the fixed platform, parallel to the first rotating joint, and serves as an actuation joint.

The fourth rotating joint is parallel to the first rotating joint and connected to the third rotating joint through a connecting rod.

The fifth rotating joint is arranged parallel to the first rotating joint and connected to the fourth rotating joint via a connecting rod.

The sixth rotating joint is arranged parallel to the second rotating joint and connected to the fifth rotating joint via a connecting rod.

The seventh rotating joint is arranged on the moving platform, parallel to the second rotating joint and connected to the sixth rotating joint via a connecting rod.

The second actuation limb includes the eighth rotating joint to the twelfth rotating joint.

The eighth rotating joint is arranged on the fixed platform, parallel to the first rotating joint and serves as an actuation joint.

The ninth rotating joint is arranged parallel to the first rotating joint and connected to the eighth rotating joint via a connecting rod.

The tenth rotating joint is arranged parallel to the first rotating joint and connected to the ninth rotating joint via a connecting rod.

The eleventh rotating joint is arranged parallel to the second rotating joint and connected to the tenth rotating joint via a connecting rod.

The twelfth rotating joint is arranged on the moving platform, parallel to the second rotating joint, and connected to the eleventh rotating joint via a connecting rod.

According to a preferred embodiment of the present disclosure, the first rotating joint is arranged on a fixed platform; the second rotating joint is arranged on the moving platform, orthogonal to the first rotating joint, and fixed with the first rotating joint via a connecting rod.

Furthermore, the twist system of the moving platform of the transmission mechanism includes two screws, and the degree of freedom is two.

According to a preferred embodiment of the present disclosure, the twist system constituted by the constraint limb is:

$${𝕊}_{l 1} = \{ \begin{matrix}{S}_{11} = {( 1 , 0 , 0 , 0 , 0 , - {L}_{11} )}^{T} \\ {S}_{12} = {( 0 , c θ , s θ , - {L}_{11} s θ , 0 , 0 )}^{T}\end{matrix} \}$$

where S₁₁ represents a first twist corresponding to a screw axis of the first rotating joint of the constraint limb, S₁₂ represents a second twist corresponding to a screw axis of the second rotating joint of the constraint limb, L₁₁ represents a component of a secondary part of the first twist S₁₁ in a Z direction, cθ and sθ express the abbreviations of cos(θ) and sin(θ), respectively, and θ represents a rotation angle of the connecting rod between the first rotating joint S₁₁ and the second rotating joint S₁₂ in the constraint limb around the first rotating joint S₁₁.

Accordingly, the constraint wrench system constituted by the constraint limb may be expressed as:

$${𝕊}_{l 1}^{r} = \{ \begin{matrix}{S}_{11}^{r} = {( 0 , 0 , 1 , {L}_{11} , 0 , 0 )}^{T} \\ {S}_{12}^{r} = {( 1 , 0 , 0 , , 0 , {L}_{11} )}^{T} \\ {S}_{13}^{r} = {( 0 , 1 , 0 , 0 , 0 , 0 )}^{T} \\ {S}_{14}^{r} = {( 0 , 0 , 0 , 0 , - s θ , c θ )}^{T}\end{matrix} \}$$

where S₁₁^{r}, S₁₂^{r}, S₁₃^{r}, S₁₄^{r} represent first to fourth constraint spiral force screw.

The twist system constituted by the first actuation limb and the second actuation limb is:

$${𝕊}_{li} = \{ \begin{matrix}{S}_{i 1} = {( 1 , 0 , 0 , 0 , 0 , 0 )}^{T} \\ {S}_{i 2} = {( 1 , 0 , 0 , 0 , {q}_{2} , {r}_{2} )}^{T} \\ {S}_{i 3} = {( 1 , 0 , 0 , 0 , {q}_{3} , {r}_{3} )}^{T} \\ {S}_{i 4} = {( 0 , c θ , s θ , {p}_{4} , {q}_{4} , {r}_{4} )}^{T} \\ {S}_{i 3} = {( 0 , c θ , s θ , {p}_{5} , {q}_{5} , {r}_{5} )}^{T}\end{matrix} \} ( i = 2 , 3 )$$

where, [symbol] , i=2, 3, represents the twist system of the first actuation limb and the second actuation limb, Sᵢ₁, Sᵢ₂, Sᵢ₃, Sᵢ₄, Sᵢ₅ i=2, 3, represent the first to fifth twists of the twist system [symbol] , i=2, 3, and q₂, r₂, q₃, r₃, p₄, q₄, r₄, p₅, q₅, r₅ represent components of a secondary part of the second to fifth twists in three directions of X, Y and Z, where p, q, r correspond to the three directions of X, Y and Z, respectively. Accordingly, the constraint wrench system constituted by the two actuation limbs may be expressed as:

$${𝕊}_{li}^{r} = {S}_{l 1}^{r} = {( 0 , 0 , 0 , 0 , - s θ , c θ )}^{T} ( i = 2 , 3 )$$

where [symbol] , i=2, 3, represents the constraint wrench system of the first actuation limb and the second actuation limb, and Sᵢ₁^{r}, i=2, 3, represents a unique constraint wrench of the constraint wrench system of the first actuation limb and the second actuation limb.

Therefore, the twist system of the moving platform can be expressed as:

$${𝕊}_{l 1} = \{ \begin{matrix}{S}_{11} = {( 1 , 0 , 0 , 0 , 0 , - {L}_{11} )}^{T} \\ {S}_{12} = {( 0 , c θ , s θ , - {L}_{11} s θ , 0 , 0 )}^{T}\end{matrix} \} .$$

On the other hand, the present disclosure provides a micro high-mobility crawling robot, which can realize high-speed locomotion without tethering. The crawling robot includes a driver, a power supply, a control module for controlling the forward and turning movements of the robot, a communication module for communicating with other mechanisms and transmitting control instructions of the robot, and a transmission mechanism for executing lifting or twisting movements. The transmission mechanism is a three-chain two-degree-of-freedom parallel mechanism. The transmission mechanism includes a fixed platform located in the lower half of the robot and a moving platform located in the upper half of the robot, where the moving platform includes two actuation limbs and a constraint limb, and each of the two actuation limbs has an actuation joint, which is respectively fixed on the fixed platform through a supporting rod; when the movements of the actuation joints of the two actuation limbs are synchronized, the transmission mechanism generates a lifting action, which causes the robot to move forward; when the movements of the driving joints of the two actuation limbs are out of synchronization, the transmission mechanism produces a twisting action, which causes the robot to turn, where the axes of the lifting action and the twisting action are orthogonal.

According to the preferred embodiment of the present disclosure, the lifting action and twisting action of the transmission mechanism can be superimposed, that is, the synchronous component of the actions of the two actuation limbs will lead to the lifting of the transmission mechanism, and the asynchronous component of the two actuation limbs will lead to the twisting of the transmission mechanism, so that the robot can move forward and turn at the same time.

According to the preferred embodiment of the present disclosure, the overall size of the micro high-mobility intelligent crawling robot is 10 mm to 100 mm.

According to the preferred embodiment of the present disclosure, the transmission mechanism is only composed of rigid composite materials and flexible polymers. According to the preferred embodiment of the present disclosure, the rigid material of the transmission mechanism is selected from carbon fiber, stainless steel and wood, and the flexible material of the transmission mechanism is selected from polyimide film, polyethylene film and the like. In an embodiment, the rigid material is carbon fiber. In an embodiment, the flexible material is a polyimide film. But the present disclosure is not limited to the listed materials.

According to a preferred embodiment of the present disclosure, the driver is a ceramic driver. In an embodiment, the driver is a piezoelectric ceramic driver, which uses the inverse piezoelectric effect of piezoelectric ceramics as a power source.

The present disclosure further provides a robot cluster, which includes any form of micro crawling robot as mentioned above.

According to the preferred embodiment of the present disclosure, the piezoelectric ceramic driver is composed of a piezoelectric ceramic sheet and an insulating elastic sheet, and the applied electric field of the electromechanical coupling effect involved in the piezoelectric ceramic driver is 200V. In an embodiment, the piezoelectric material of the driver can be single crystal piezoelectric ceramics or polycrystalline piezoelectric ceramics or shape memory alloy or shape memory polymer or dielectric elastomer and other electroactive soft materials. In an embodiment, the polycrystalline piezoelectric ceramics with a thickness of 127 μm are used, and the PZT-5H type polycrystalline piezoelectric ceramics are preferably selected to obtain the best driving effect, but the present disclosure is not limited to the materials listed above.

The micro crawling robot according to the present disclosure adopts a two-degree-of-freedom parallel mechanism with three branch chains as a transmission mechanism, and converts the shape change of the piezoelectric ceramic driver into the crawling power of the robot. In an embodiment, the transmission mechanism, as a parallel mechanism, uses the lever principle to amplify the tiny deformation of the micro-driver and convert it into the lifting and twisting actions of the transmission mechanism. When the robot crawls on the ground, the transmission mechanism lifts the upper half of the robot and moves forward through a lifting action, thus realizing the forward action of the robot; through a twisting action, the transmission mechanism twists the forward direction while the upper half of the robot moves forward, thus realizing the turning action of the robot. The micro crawling robot uses the transmission mechanism according to the present disclosure to realize untethered locomotion.

According to the microrobot system of the present disclosure, through efficient transmission mechanism design, lightweight transmission mechanism manufacture and high-performance piezoelectric ceramic driver, the robot has extremely high movement ability, can carry batteries and electronic components needed for driving itself, and realizes high-speed autonomous movement without tethering. In an embodiment, a tiny high-frequency swing is generated by the electromechanical coupling effect of the high-performance piezoelectric ceramic driver, which is amplified by the micro-transmission mechanism to drive the robot to achieve high-speed crawling and turning. Piezoelectric ceramic driver consists of two ceramic stacks. When the two ceramic stacks swing in the same direction, the robot moves forward, and when the two ceramic stacks swing in the opposite direction, the robot turns.

The beneficial effects of the present disclosure at least include the following.

The inventor first proposed a two-degree-of-freedom micro-parallel mechanism as the transmission mechanism of microrobot; the micro two-degree-of-freedom parallel transmission mechanism according to the present disclosure has the characteristics of exquisite structure and good transmission performance.

For the first time, the micro crawling robot according to the present disclosure can independently lift (forward power) and twist (turn power) when moving forward and turning.

The micro crawling robot according to the present disclosure has the advantages of high moving speed, light weight and low manufacturing cost. The micro crawling robot according to the present disclosure adopts piezoelectric ceramic material as the driver material, and the driver manufactured by using the inverse piezoelectric effect of piezoelectric ceramics as the power source has a wide working frequency range and can be adjusted, so that the speed of the micro crawling robot can be fast or slow, and is suitable for different application scenarios.

The micro crawling robot according to the present disclosure adopts the micro parallel mechanism with a flexible rotating joint as the transmission mechanism, which greatly reduces the mass of the robot and improves the transmission efficiency and flexibility of the robot.

According to the combination of the driver and the transmission mechanism of the micro crawling robot, the working efficiency is extremely high, and the battery life under the same size is greatly prolonged.

The micro crawling robot according to the present disclosure adopts an intelligent integrated design scheme, so that the crawling robot can carry a driver, a transmission mechanism, a controller, a power supply and communication equipment, and can realize free crawling in the environment without external power supply and communication with the outside world during operation.

The micro crawling robot according to the present disclosure has the advantages of small volume, high integration, strong mobility and intelligence. The overall size of the micro crawling robot according to the present disclosure is 10 mm to 100 mm, the characteristic length is 4.1 cm, the highest average speed is 27.3 cm/s, the relative speed reaches 6.6 times of the body length per second, and the turning radius is 1.7 cm, so that the non-tethered movement can be realized. Breaking through the limitation of the prior art, it is the first time to realize that the micro crawling robot with a similar size can reach the movement speed of more than 5 times of the body length per second in the untethered locomotion state, which is a major technological innovation in the field of micro crawling robots.

### BRIEF DESCRIPTION OF DRAWINGS

FIG. 1(a) shows an equivalent schematic diagram of a transmission mechanism according to the present disclosure; FIG. 1(b) shows a mechanical design diagram of the transmission mechanism according to the present disclosure; and FIG. 1(c) shows the overall mechanical diagram of the transmission mechanism of the present disclosure, and 1—fixed platform, 2—moving platform, 3—object-centered fixed platform, 4—object-centered moving platform, 5—crank slider connecting rod for connecting a piezoelectric ceramic driver, and 6—side plate for installing the control system and battery. S₁₁-S₃₅ represent the axes of rotation of the parallel mechanism.

FIG. 2 shows the process flow chart of obtaining a complete micro-transmission mechanism by laser engraving patterns.

FIGS. 3(a)-3(c) is a diagram showing the installation process of the closed chain of the transmission mechanism, where FIG. 3(a) the tiled structure is turned to the back; FIG. 3(b) connecting rods are spliced by a groove structure to form a closed chain; and FIG. 3(c) glue is applied to fix the mechanical connection.

FIGS. 4(a)-4(b) is a diagram showing the driver assembly process of the micro crawling robot according to the present disclosure, where FIG. 4(a) the tail of the driver is connected to the side plate of the transmission mechanism, FIG. 4(b) the driver head is connected to the connecting rod of the transmission mechanism.

FIGS. 5(a)-5(b) is a schematic diagram showing the movement of the micro crawling robot according to the present disclosure, where FIG. 5(a) the synchronous action driven by piezoelectric ceramics leads to the lifting of the transmission mechanism; and FIG. 5(b) the asynchronous action driven by piezoelectric ceramics leads to the twisting of the transmission mechanism.

FIG. 6 is a diagram showing an actual product of the micro crawling robot according to the present disclosure.

### DESCRIPTION OF EMBODIMENTS

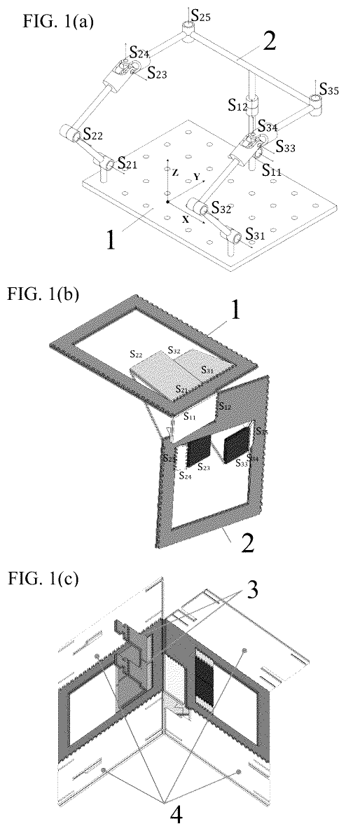

The equivalent principle of the miniature three-chain two-degree-of-freedom parallel transmission mechanism according to the present disclosure is shown in FIGS. 1(a)-1(c).

In the theoretical model of the transmission mechanism in FIG. 1(a), the moving platform 2 of the parallel mechanism is connected to the fixed platform 1 of the parallel mechanism in a fixed way, the third rotating joint S₂₁ and the eighth rotating joint S₃₁ on the moving platform 2 are rotatably connected to the inner side of the frame 3 in turn, and the first rotating joint S₁₁ is rotatably connected to the outer side of the fixed platform 3 in the real object. The relative positional relationship between the rotating joints is as follows:

The first rotating joint S₁₁ is arranged on the fixed platform.

The second rotating joint S₁₂ is arranged on the moving platform, perpendicular to the first rotating joint S₁₁ and connected by a connecting rod.

The third rotating joint S₂₁ is arranged on the fixed platform, parallel to the first rotating joint S₁₁, and serves as an actuation joint.

The fourth rotating joint S₂₂ is arranged parallel to the first rotating joint S₁₁ and connected to the third rotating joint S₂₁ via a connecting rod.

The fifth rotating joint S₂₃ is arranged parallel to the first rotating joint S₁₁ and connected to the fourth rotating joint S₂₂ via a connecting rod.

The sixth rotating joint S₂₄ is arranged parallel to the second rotating joint S₁₂ and connected to the fifth rotating joint S₂₃ via a connecting rod.

The seventh rotating joint S₂₅ is arranged on the moving platform, parallel to the second rotating joint S₁₂, and connected to the sixth rotating joint S₂₄ via a connecting rod.

The eighth rotating joint S₃₁ is arranged on the fixed platform, parallel to the first rotating joint S₁₁, and serves as an actuation joint.

The ninth rotating joint S₃₂ is arranged parallel to the first rotating joint S₁₁ and connected to the eighth rotating joint S₃₁ via a connecting rod.

The tenth rotating joint S₃₃ is arranged parallel to the first rotating joint S₁₁ and connected to the ninth rotating joint S₃₂ via a connecting rod.

The eleventh rotating joint S₃₄ is arranged parallel to the second rotating joint S₁₂ and connected to the tenth rotating joint S₃₃ via a connecting rod.

The twelfth rotating joint S₃₅ is arranged on the moving platform, parallel to the second rotating joint S₁₂, and connected to the eleventh rotating joint S₃₄ via a connecting rod.

Compared with the mechanical design model of the transmission mechanism in FIG. 1(b), in the mechanical design model of the overall structure of the robot in FIG. 1(c), two crank-slider connecting rods 5 are added for connecting the piezoelectric ceramic driver and the actuation limbs of the parallel mechanism; and four side plates 6 are used for installing components such as a power driver and a controller of the robot.

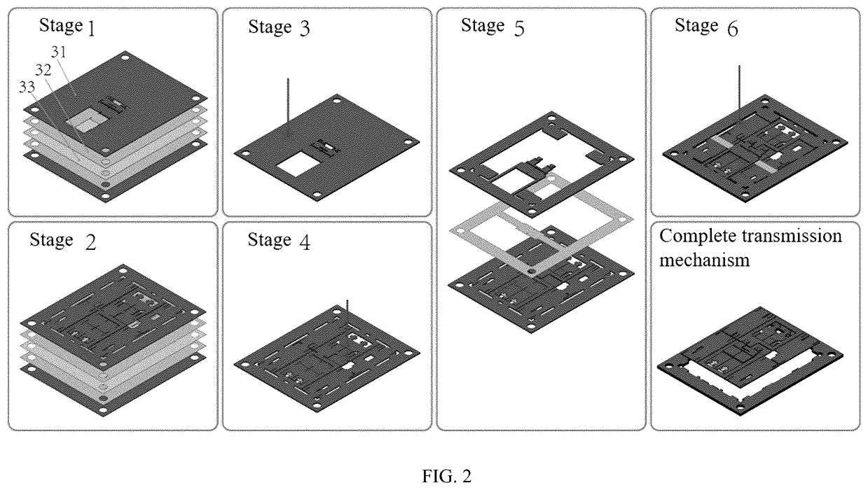

The laser processing and heat pressing process shown in FIG. 2 involves a carbon fiber sheet 31, an adhesive film 32 and a polyimide film 33. The whole process is divided into six stages, involving three stacks in total, including stage 1-laser processing each layer of materials and hot pressing to form a stack No. 1, stage 2-laser processing each layer of materials and hot pressing to form the a stack No. 2, stage 3-laser processing the stack No. 1 after hot pressing in stage 1, stage 4-laser processing the stack No. 2 after hot pressing in stage 1, stage 5-hot pressing the stack No. 1 and the stack No. 2 to form a stack No. 3, stage 6-laser processing the stack No. 3 to form a transmission mechanism. The transmission mechanism thus obtained has high maneuverability and can realize the forward movement and turning movement of the crawling robot.

There are three branch chains in this mechanism, two of which are actuation limbs, the two actuation limbs are similar, and the remaining one is a constraint limb.

For the constraint limb, the twist system constituted by the constraint limb is:

$${𝕊}_{l 1} = \{ \begin{matrix}{S}_{11} = {( 1 , 0 , 0 , 0 , 0 , - {L}_{11} )}^{T} \\ {S}_{12} = {( 0 , c θ , s θ , - {L}_{11} s θ , 0 , 0 )}^{T}\end{matrix} \}$$

where S₁₁ represents a first twist corresponding to a screw axis of the first rotating joint of the constraint limb, S₁₂ represents a second twist corresponding to a screw axis of the second rotating joint of the constraint limb, L₁₁ represents a component of a secondary part of the first twist S₁₁ in a Z direction, cθ and sθ express abbreviations of cos(θ) and sin(θ), respectively, and θ represents a rotation angle of the connecting rod between the first rotating joint S₁₁ and the second rotating joint S₁₂ in the constraint limb around the first rotating joint S₁₁.

Accordingly, the constraint wrench system constituted by the constraint limb may be expressed as:

$${𝕊}_{l 1}^{r} = \{ \begin{matrix}{S}_{11}^{r} = {( 0 , 0 , 1 , {L}_{11} , 0 , 0 )}^{T} \\ {S}_{12}^{r} = {( 1 , 0 , 0 , , 0 , {L}_{11} )}^{T} \\ {S}_{13}^{r} = {( 0 , 1 , 0 , 0 , 0 , 0 )}^{T} \\ {S}_{14}^{r} = {( 0 , 0 , 0 , 0 , - s θ , c θ )}^{T}\end{matrix} \}$$

where S₁₁^{r}, S₁₂^{r}, S₁₃^{r}, S₁₄^{r} represent first to fourth constraint wrenches.

The twist system constituted by the two similar actuation limbs is:

$${𝕊}_{li} = \{ \begin{matrix}{S}_{i 1} = {( 1 , 0 , 0 , 0 , 0 , 0 )}^{T} \\ {S}_{i 2} = {( 1 , 0 , 0 , 0 , {q}_{2} , {r}_{2} )}^{T} \\ {S}_{i 3} = {( 1 , 0 , 0 , 0 , {q}_{3} , {r}_{3} )}^{T} \\ {S}_{i 4} = {( 0 , c θ , s θ , {p}_{4} , {q}_{4} , {r}_{4} )}^{T} \\ {S}_{i 5} = {( 0 , c θ , s θ , {p}_{5} , {q}_{5} , {r}_{5} )}^{T}\end{matrix} \} , ( i = 2 , 3 )$$

where, [symbol] , i=2, 3, represents the twist system of the first actuation limb and the second actuation limb, Sᵢ₁, Sᵢ₂, Sᵢ₃, Sᵢ₄, Sᵢ₅, i=2, 3, represent first to fifth twist of the twist system [symbol] ₗᵢ, i=2, 3, and q₂, r₂, q₃, r₃, p₄, q₄, r₄, p₅, q₅, r₅ represent components of a secondary part of the second to fifth twists in three directions of X, Y and Z, where p, q, r correspond to the three directions of X, Y and Z, respectively.

Accordingly, the constraint wrench system constituted by the two actuation limbs may be expressed as:

$${𝕊}_{li}^{r} = {S}_{l 1}^{r} = {( 0 , 0 , 0 , 0 , - s θ , c θ )}^{T} ( i = 2 , 3 )$$

where [symbol] , i=2, 3, represents the constraint wrench system of the first actuation limb and the second driving branch, and Sᵢ₁^{r}, i=2, 3, represents a unique constraint force screw of the constraint wrench system of the first actuation limb and the second actuation limb.

According to the screw theory of a parallel mechanism, the constraint wrench system of the moving platform is the union of all the constraint wrench systems of all branch chains, and the twist system is the intersection of twist system of all the branch chains, and thus the twist system of the moving platform can be expressed as:

$${𝕊}_{l 1} = \{ \begin{matrix}{S}_{11} = {( 1 , 0 , 0 , 0 , 0 , - {L}_{11} )}^{T} \\ {S}_{12} = {( 0 , c θ , s θ , - {L}_{11} s θ , 0 , 0 )}^{T}\end{matrix} \}$$

where S₁₁ represents a first twist corresponding to a screw axis of the fourth rotating joint of the constraint limb, S₁₂ represents a second twist corresponding to a screw axis of the fifth rotating joint of the constraint limb, L₁₁ represents a component of a secondary part of the first twist S₁₁ in a Z direction, cθ, and sθ express abbreviations of cos(θ), and sin(θ), respectively, and θ represents a rotation angle of the connecting rod between the first rotating joint S₁₁ and the second rotating joint S₁₂ in the constraint limb around the first rotating joint S₁₁.

Because the twist system of the moving platform contains two screws, the degree of freedom of the parallel mechanism is two.

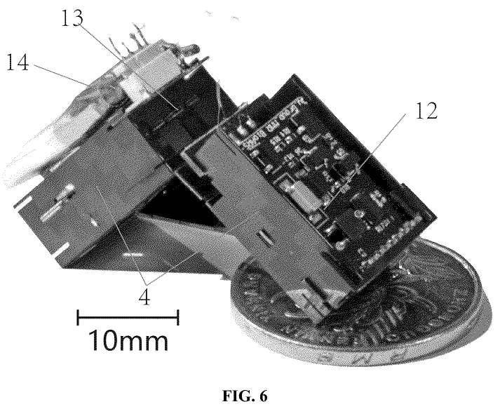

As shown in FIG. 6, in addition to the transmission mechanism, the robot further includes a controller 12, a driver 13 and a battery 14 installed on the side plate. When receiving the forward command, the driving joints S₂₁ and S₃₁ drive the connecting rod to lift upward under the action of the rotating joint S₁₂, and when the transmission mechanism carries out a lifting action, the upper half of the robot lifts relative to the lower half, thus realizing the forward movement of the crawling robot relative to the ground. When the transmission mechanism is twisted, the upper half of the robot turns relative to the lower half, thus realizing the turning movement of the crawling robot relative to the ground.

### Example 1

A micro intelligent crawling robot with high mobility included a piezoelectric ceramic driver, a transmission mechanism, a battery and a controller. The crawling robot had a length of 41 mm and a width of 18 mm, and its overall size was similar to that of a coin.

The piezoelectric ceramic driver consisted of four piezoelectric ceramic pieces and a carbon fiber piece. The piezoelectric ceramic material was polycrystalline piezoelectric ceramic with a mark of PZT-5H, and the positive and negative surfaces of the piezoelectric ceramic pieces were coated with nickel alloy electrodes. Four piezoelectric ceramics were distributed in pairs, and the carbon fiber sheet was sandwiched in the middle.

The nickel alloy electrode on the surface of the piezoelectric ceramic driver is led out through the copper foil, and the nickel-titanium alloy electrode and the copper foil are connected through epoxy conductive adhesive to realize conduction.

The transmission mechanism is a miniature two-degree-of-freedom parallel mechanism with flexible hinges, and its materials are carbon fiber sheets, adhesive films and polyimide films, and the processing methods are laser processing and hot pressing.

In an embodiment, the corresponding patterns were respectively engraved on the carbon fiber sheet, the adhesive film and the polyimide film materials by laser, and the materials were bonded together in sequence; and after repeating for many times, a miniature connecting rod structure was obtained, and specific parts in the structure were connected together, so that a complete miniature transmission mechanism could be obtained.

The power of the micro high-mobility intelligent crawling robot is provided by the piezoelectric ceramic driver, and is transmitted by the transmission mechanism into the lifting motion or twisting motion of the crawling robot body, thus realizing the forward and turning motions of the crawling robot.

Furthermore, the piezoelectric ceramic driver can produce swing deformation with a micron amplitude under an AC voltage, and this swing action is converted into a rotation with a larger amplitude by the transmission mechanism.

In this embodiment, the driving voltage applied to the piezoelectric ceramic driver was 250V, and the amplitude of the swing deformation generated by the piezoelectric ceramic driver was 400 μm. The displacement of the end of the piezoelectric ceramic driver was measured by a laser rangefinder, and a swing of 400 μm of the driver made the transmission mechanism rotate by 30 degrees.

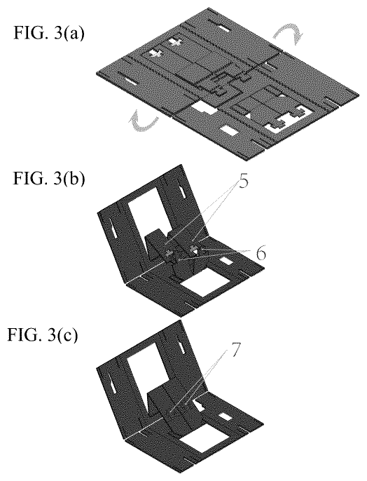

The installation process of the micro-transmission mechanism is shown in FIG. 3. First, the laser-processed transmission mechanism was turned over, and the designed connection points at 5 and 6 on the transmission mechanism were buckled to realize the closed-loop process of the structure, and the connection point 7 was fixed with glue.

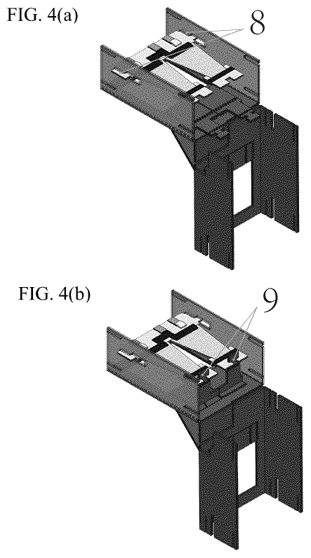

As shown in FIGS. 4(a)-4(b), the assembly process of the micro high-mobility intelligent crawling robot is as follows: firstly, the tail of the piezoelectric ceramic driver 8 was embedded into two mounting holes on the side plate of the transmission mechanism, and then the two input ends of the transmission mechanism 9 were embedded into the front end of the piezoelectric ceramic driver, and the four mounting points mentioned above were all fixed with glue.

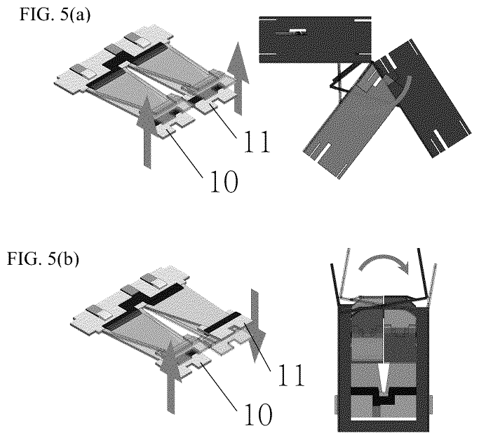

The movement principle of the micro high-mobility intelligent crawling robot is shown in FIGS. 5(a)-5(b). The piezoelectric ceramic driver has two ceramic stack structures (10—left ceramic stack and 11—right ceramic stack), which can generate independent actions. When the actions of two ceramic stacks are synchronized, the transmission mechanism can produce a lifting action, and then the robot will move forward; when the actions of two ceramic stacks are out of sync, the transmission mechanism can produce a twisting action, and the robot will turn. When two ceramic stacks are driven at the same time, the synchronous component of the two ceramic stacks will cause a lifting action of the transmission mechanism, and the asynchronous component of the two ceramic stacks will cause the twisting action of the transmission mechanism. For the transmission mechanism, the lifting and twisting actions can be superimposed.

### Example 2

By using the method of Example 1, the mass of the prepared piezoelectric ceramic driver was 280 mg, the mass of the micro transmission mechanism was 800 mg, and the mass of the finally assembled micro high-mobility intelligent crawling robot was 4.34 g.

The moving speed of the robot was tested. The robot was placed on a horizontal platform, and the same voltage was applied to both ends of the piezoelectric ceramic driver of the robot. The moving distance of the robot in a certain time was photographed by a camera (Canon 5d mark2), and the crawling speed of the robot was calculated. When the driving frequency was 60 Hz, the crawling speed of the robot reached 27.4 cm/s, which was much higher than the movement speed of the existing micro crawling robot (Zhang, J., & Li, Z. (2018). Power and control autonomy for high-speed locomotion with an insect-scale legged robot. IEEE Robotics and Automation Letters, 3(2), 1079-1086). At the same time, in the turning test, the robot was placed on a horizontal platform, different voltages were applied to both ends of the piezoelectric ceramic driver, the turning process of the robot was photographed with a camera at a certain time, and the turning radius of the robot is calculated. When driving signals of 30 Hz on the left side and 60 Hz on the right side were applied to the robot, the turning radius of the robot was 1.7 cm, which showed extremely high maneuverability.

What is claimed is:

1. A transmission mechanism of a micro crawling robot, wherein the transmission mechanism is a parallel mechanism with three branch chains and two degrees of freedom, and comprises:
a fixed platform and a moving platform;
a constraint limb comprising a first rotating joint S₁₁ and a second rotating joint S₁₂, which generate functions of constraining a lifting motion and a twisting motion of the moving platform, respectively;
a first actuation limb comprising third to seventh rotating joints S₂₁-S₂₅, wherein the third rotating joint S₂₁ is an actuation joint and the fourth to seventh rotating joints are transmission rotating joints; and
a second actuation limb comprising eighth to twelfth rotating joints S₃₁-S₃₅, wherein the eighth rotating joint S₃₁ is an actuation joint, and the ninth to twelfth rotating joints are transmission rotating joints;
wherein when movements of the third rotating joint S₂₁ and the eighth rotating joint S₃₁ are synchronized, the moving platform of the transmission mechanism generates the lifting motion relative to the fixed platform, allowing the micro crawling robot to move forward; and when movements of the third rotating joint S₂₁ and the eighth rotating joint S₃₁ are out of synchronization, the moving platform of the transmission mechanism generates the twisting motion relative to the fixed platform, allowing the micro crawling robot to turn, and wherein moving axes of the lifting motion and the twisting motion are orthogonal; wherein
the first rotating joint S₁₁ is arranged on the fixed platform;
the second rotating joint S₁₂ is arranged on the moving platform, perpendicular to the first rotating joint S₁₁ and connected via a second connecting rod;
the third rotating joint S₂₁ is arranged on the fixed platform, parallel to the first rotating joint S₁₁, and serves as an actuation joint;
the fourth rotating joint S₂₂ is arranged parallel to the first rotating joint S₁₁ and connected to the third rotating joint S₂₁ via a fourth connecting rod;
the fifth rotating joint S₂₃ is arranged parallel to the first rotating joint S₁₁ and connected to the fourth rotating joint S₂₂ via a fifth connecting rod;
the sixth rotating joint S₂₄ is arranged parallel to the second rotating joint S₁₂ and connected to the fifth rotating joint S₂₃ via a sixth connecting rod;
the seventh rotating joint S₂₅ is arranged on the moving platform, parallel to the second rotating joint S₁₂, and connected to the sixth rotating joint S₂₄ via a seventh connecting rod;
the eighth rotating joint S₃₁ is arranged on the fixed platform, parallel to the first rotating joint S₁₁, and serves as an actuation joint;
the ninth rotating joint S₃₂ is arranged parallel to the first rotating joint S₁₁ and connected to the eighth rotating joint S₃₁ via a ninth connecting rod;
the tenth rotating joint S₃₃ is arranged parallel to the first rotating joint S₁₁ and connected to the ninth rotating joint S₃₂ via a tenth connecting rod;
the eleventh rotating joint S₃₄ is arranged parallel to the second rotating joint S₁₂ and connected to the tenth rotating joint S₃₃ via a eleventh connecting rod; and
the twelfth rotating joint S₃₅ is arranged on the moving platform, parallel to the second rotating joint S₁₂, and connected to the eleventh rotating joint S₃₄ via a twelfth connecting rod.

2. The transmission mechanism according to claim 1, wherein the lifting motion and the twisting motion of the transmission mechanism are superimposable, thereby allowing the micro crawling robot to move forward and turn at the same time.

3. The transmission mechanism according to claim 1, wherein the constraint limb constitutes a twist system [symbol] and a constraint wrench system [symbol] , wherein the twist system [symbol] is:
$${𝕊}_{l 1} = \{ \begin{matrix}{S}_{11} = {( 1 , 0 , 0 , 0 , 0 , - {L}_{11} )}^{T} \\ {S}_{12} = {( 0 , c θ , s θ , - {L}_{11} s θ , 0 , 0 )}^{T}\end{matrix} \}$$
where S₁₁ represents a first twist corresponding to a screw axis of the first rotating joint of the constraint limb, S₁₂ represents a second twist corresponding to a screw axis of the second rotating joint of the constraint limb, L₁₁ represents a component of a secondary part of the first twist S₁₁ in a Z direction, cθ and sθ express abbreviations of cos(θ) and sin(θ), respectively, and θ represents a rotation angle of the second connecting rod between the first rotating joint S₁₁ and the second rotating joint S₁₂ in the constraint limb around the first rotating joint S₁₁; and
wherein the constraint wrench system is:
$${𝕊}_{l 1}^{r} = \{ \begin{matrix}{S}_{11}^{r} = {( 0 , 0 , 1 , {L}_{11} , 0 , 0 )}^{T} \\ {S}_{12}^{r} = {( 1 , 0 , 0 , , 0 , {L}_{11} )}^{T} \\ {S}_{13}^{r} = {( 0 , 1 , 0 , 0 , 0 , 0 )}^{T} \\ {S}_{14}^{r} = {( 0 , 0 , 0 , 0 , - s θ , c θ )}^{T}\end{matrix} \}$$
where S₁₁^{r}, S₁₂^{r}, S₁₃^{r}, S₁₄^{r} represent first to fourth constraint wrenches.

4. The transmission mechanism according to claim 3, wherein the first actuation limb and the second actuation limb constitute a twist system [symbol] and a constraint wrench system [symbol] ^{r}, wherein the twist system [symbol] is:
$${𝕊}_{li} = \{ \begin{matrix}{S}_{i 1} = {( 1 , 0 , 0 , 0 , 0 , 0 )}^{T} \\ {S}_{i 2} = {( 1 , 0 , 0 , 0 , {q}_{2} , {r}_{2} )}^{T} \\ {S}_{i 3} = {( 1 , 0 , 0 , 0 , {q}_{3} , {r}_{3} )}^{T} \\ {S}_{i 4} = {( 0 , c θ , s θ , {p}_{4} , {q}_{4} , {r}_{4} )}^{T} \\ {S}_{i 5} = {( 0 , c θ , s θ , {p}_{5} , {q}_{5} , {r}_{5} )}^{T}\end{matrix} \} , i = 2 , 3$$
where [symbol] , i=2, 3, represents the twist system of the first actuation limb and the second actuation limb, Sᵢ₁, Sᵢ₂, Sᵢ₃, Sᵢ₄, Sᵢ₅, i=2, 3, represent first to fifth twists of the twist system [symbol] , i=2, 3, and q₂, r₂, q₃, r₃, p₄, q₄, r₄, p₅, q₅, r₅ represent components of a secondary part of the second to fifth twists in three directions of X, Y and Z, where p, q, r correspond to the three directions of X, Y and Z, respectively; and
wherein the constraint wrench system is:
$${𝕊}_{li}^{r} = {S}_{i 1}^{r} = {( 0 , 0 , 0 , 0 , - s θ , c θ )}^{T} , i = 2 , 3$$
where [symbol] ^{r}, i=2, 3, represents the constraint wrench system of the first actuation limb and the second actuation limb, and Sᵢ₁^{r}, i=2, 3, represents a unique constraint force screw of the constraint wrench system of the first actuation limb and the second actuation limb.

5. The transmission mechanism according to claim 1, wherein the transmission mechanism comprises a rigid composite material and a flexible polymer.

6. The transmission mechanism according to claim 5, wherein the rigid composite material is selected from carbon fiber, stainless steel or wood, and the flexible polymer is selected from polyimide film or polyethylene film.

7. The transmission mechanism according to claim 6, wherein the rigid composite material is carbon fiber.

8. The transmission mechanism according to claim 6, wherein the flexible polymer is a polyimide film.

9. A micro crawling robot, comprising a power supply, a micro-driver, a controller, a communication module and the transmission mechanism according to claim 1, wherein the micro crawling robot moves forward and/or turns under an action of the transmission mechanism according to control instructions, achieving untethered motion.

10. The micro crawling robot according to claim 9, wherein the micro-driver is a piezoelectric ceramic driver.

11. A robot cluster, wherein the robot cluster comprises the micro crawling robot according to claim 9.
